(19) United States
(12) Patent Application Publication
(10) Pub. No.: US 2005/0180742 A1
(43) Pub. Date: Aug. 18, 2005

(54) Motor to drive an IRIS diaphragm, IRIS diaphragm driving apparatus, and a camera apparatus having the same

(75) Inventors: Yeong-hyo Jeong, Suwon-si (KR); Eui-kuen Oh, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/038,588

(22) Filed: Jan. 21, 2005

Related U.S. Application Data
(60) Provisional application No. 60/536,986, filed on Jan. 20, 2004.

(30) Foreign Application Priority Data
Feb. 25, 2004 (KR) 2004-12625

(51) Int. Cl. G03B 9/08

(52) U.S. Cl. 396/451; 396/463

(57) ABSTRACT

A motor to drive an iris diaphragm having a motor housing formed within the lens barrel to provide a light path, a stator assembly supported in the motor housing, and a rotor rotatably disposed within the stator assembly to move the iris diaphragm by a movement thereof, the rotor having a center aperture through which a light passes. Additionally, an iris diaphragm driving apparatus has an iris diaphragm installed in a lens barrel, and a motor which is installed in the lens barrel and drives the iris diaphragm in accordance with a movement thereof.

### CROSS-REFERENCE TO RELATED APPLICATION

This application claims the benefit of U.S Provisional Patent Application No. 60/536,986 filed Jan. 20, 2004 in the U.S Patent and Trademark Office, and Korean Application No. 2004-12625, filed Feb. 25, 2004, the disclosures of which are incorporated herein by reference.

### BACKGROUND OF THE INVENTION

1. Field of the Invention

The present invention relates to an image photographing apparatus which captures image information and records and stores the captured image, and more particularly, to a motor to drive an iris diaphragm, an iris diaphragm driving apparatus, and a camera apparatus having the same therein.

2. Description of the Related Art

A camcorder is a representative example of an image recording/reproducing apparatus, which is capable of capturing not only still images but also motion images. The camcorder generally includes a camera device, a signal converter, a deck device to record/reproduce captured images, and a display device. Also, the camcorder usually records captured image information by the use of cassette tapes as a recording medium.

Recently, research and development have been actively undertaken to develop a compact-sized image information recording/reproducing apparatus making use of, for example, a hard disk drive. Because the recording/reproducing apparatus with an installed hard disk drive does not need a separate deck device, the goal of making the apparatus compact is obtained.

Meanwhile, the camera device of a camcorder is installed in the camcorder body as one unit module. The camera device generally includes a lens barrel that houses various lenses such as focusing lens and zoom lens therein. Additionally, a motor is usually included in the lens barrel to drive the focusing lens and the zoom lens.

An iris diaphragm adjusts the amount of light entering the lens barrel. The iris diaphragm is moved by a separate driving motor to adjust the amount of entering light. The driving motor is installed outside the lens barrel.

In the conventional construction as described above, a plurality of drive motors are installed outside the lens barrel. When considering a need to install a lens drive motor into account, reducing the size of the camera device is quite difficult.

Additionally, the lens barrel usually takes on a cylindrical configuration, and has a limitation in design in an appearance thereof. That is, considering that a driving motor is mounted on the lens barrel, the lens barrel has an angular outer configuration.

### SUMMARY OF THE INVENTION

Therefore, an aspect of the present invention provides a motor to drive an iris diaphragm of a camera apparatus and an iris diaphragm driving apparatus, which may be installed within a lens barrel and may therefore provide improved structure and compactness, and a camera apparatus having the same installed therein.

Accordingly, to an aspect of the invention, a motor to drive an iris diaphragm during an adjustment of an amount of light entering a lens barrel, comprises: a motor housing formed within the lens barrel to provide a light path; a stator assembly supported in the motor housing; and a rotor rotatably disposed within the stator assembly to move the iris diaphragm as a result of a movement of the rotor, the rotor having a center aperture through which a light passes.

The motor housing rotatably supports the iris diaphragm.

The rotor comprises a driving pin to move the iris diaphragm with the movement thereof.

The motor housing comprises: a shaft boss to rotatably support the iris diaphragm; and a guide part to guide the movement of the driving pin.

Further, a housing cover is attached to the motor housing to prevent the iris diaphragm from releasing from the shaft boss and the driving pin.

The housing cover comprises: an engagement hole corresponding to the shaft boss; and a supporting slit provided in register with the guiding part to support the driving pin.

A plurality of driving pins are arranged at uniform intervals with respect to the light path. Each of the driving pins is integrally formed with the rotor.

The stator assembly comprises: a hollow-type bobbin having a coil wounded around an outer circumference; a first stator member engaged with a first end of the hollow-type bobbin, and having first fastening teeth formed at equal intervals; and a second stator member engaged with a second end of the hollow-type bobbin in alignment with the first stator member, the second stator member having second fastening teeth formed at equal intervals and in staggered manner with respect to the first fastening teeth.

The motor housing comprises: a first housing enclosing to support one side of the stator assembly, and having a hollow space therein to provide the light path; and a second housing formed in alignment with the first housing with the stator assembly interposed therebetween, the second housing having a hollow space therein to provide the light path.

The rotor is rotatably supported in the motor housing. The rotor has a plurality of bearing receiving holes on the outer circumference, and the motor housing has a bearing guide hole. The rotor is a cylindrical magnet which is integrally formed with the driving pin and magnetized at predetermined intervals along the direction of rotation.

The rotor comprises: a cylindrical magnet magnetized at predetermined intervals along the direction of rotation, and rotatably supported in the motor housing; a tubular sleeve connected to a first end of the cylindrical magnet, and rotatably disposed within the stator assembly; and a plate connected to the first end of the magnet, and having a driving pin to move the iris diaphragm with the driving pin's movement.

The driving pin is integrally formed with the plate, and movably supported in the motor housing.

The iris diaphragm comprises a plurality of lens shutters which are rotatably disposed on the housing.

A housing cover is further provided to engage with the motor housing so as to prevent the separation of the iris diaphragm.

According to another aspect of the present invention, a motor to drive an iris diaphragm, comprises: a driving part comprising a rotor to provide a light path at the center of rotation, and a stator assembly provided at the outer side of the rotor; a motor housing to enclose the driving part therein, and to provide the light path; and a housing cover removably engaged with the motor housing. The rotor opens and closes the light path by moving the iris diaphragm interposed between the housing cover and the motor housing in accordance with a movement of the rotor.

Further, an iris diaphragm driving apparatus, comprises: an iris diaphragm, disposed on a light path of a lens barrel, to adjust an amount of entering light in accordance with a moving position thereof; and a driving unit disposed in the lens barrel to drive the iris diaphragm, and to provide a light path at the center of rotation through which the entering light passes.

The driving unit comprises: a motor housing to support the iris diaphragm, and to be disposed within the lens barrel; a stator assembly disposed within the motor housing; and a rotor rotatably disposed within the stator assembly to move the iris diaphragm in accordance with a movement of the rotor.

The rotor comprises at least one driving pin to move the iris diaphragm in accordance with a movement thereof.

The motor housing comprises: a shaft boss rotatably to support the iris diaphragm; and a guidance part to guide the movement of the driving pin.

The iris diaphragm comprises a plurality of lens shutters which are rotatably disposed on the motor housing.

The plurality of lens shutters each comprises: a shaft hole as a center of rotation; and a cam slit to engage with the driving pin. According to an aspect of the invention, the cam slit takes on a substantially linear configuration and has a predetermined length. According to another aspect of the invention, the cam slit takes on a substantially curved configuration and has a predetermined length, and the lens shutter is movable to obtain an f-number which is set in proportion to the unit rotation angle of the rotor.

Three lens shutters are rotatably arranged around the light path in a radial direction at equal intervals, and three driving pins are provided in alignment with the three lens shutters.

A housing cover is further provided, which is removably attached to the motor housing, to rotatably support the iris diaphragm which is interposed between the housing cover and the motor housing.

According to another aspect of the present invention, a camera apparatus, comprises: a lens barrel; a zoom lens module installed within the lens barrel; a focusing lens module installed within the lens barrel; an iris diaphragm movably installed between the zoom lens module and the focusing lens module, to adjust an amount of entering light in accordance with a moving position thereof; and a driving unit installed within the lens barrel to drive the iris diaphragm, and to provide a light path at a center thereof through which the light past the zoom lens module is passed.

The driving unit comprises: a motor housing installed within the lens barrel, to rotatably support the iris diaphragm; a stator assembly installed within the motor housing; and a rotor rotatably disposed within the stator assembly to move the iris diaphragm in accordance with a movement of the rotor.

The rotor comprises at least one driving pin to move the iris diaphragm in accordance with a movement thereof.

The iris diaphragm comprises a plurality of lens shutters which are rotatably disposed on the motor housing.

The plurality of lens shutters each comprises: a shaft hole as a center of rotation; and a cam slit to engage with the driving pin, the driving pin being movable in engagement with the cam slit.

The rotor is rotatably supported in the motor housing, and has a hollow hole therein so as to provide a light path at the center of rotation.

At least one of the zoom lens module and the focusing lens module is disposed in the hollow hole of the rotor.

The driving pin is formed by insert-molding such that the driving pin is exposed through one end of the rotor.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic sectional view of a camera apparatus according to an embodiment of the present invention;

FIG. 2 is an exploded perspective view of an iris diaphragm driving apparatus of the camera apparatus of FIG. 1;

FIG. 3 is a sectional view of the iris diaphragm driving apparatus of FIG. 2 in assembled state;

FIG. 4 is a plan view illustrating the iris diaphragm of FIG. 3 being assembled with a motor;

FIGS. 5A and 5B are perspective views of a rotor of FIG. 2 being assembled with a stator assembly;

FIGS. 6A and 6B are perspective views of the rotor of FIG. 2 being assembled with a stator assembly;

FIG. 7 is a perspective view of the iris diaphragm driving apparatus of FIG. 2 in an assembled state;

FIGS. 8A and 8B are plan views illustrating the iris diaphragm of FIG. 4 operating in accordance with the movement of the rotor in sequence; and

FIGS. 9 and 10 are schematic plan views illustrating an iris diaphragm driving apparatus according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

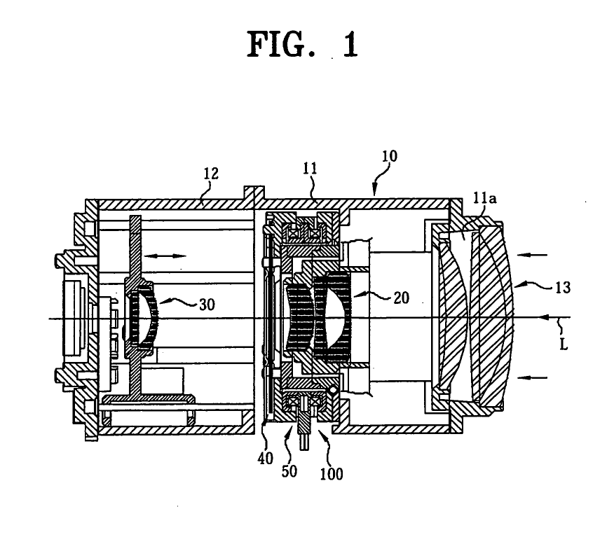

Referring to FIG. 1, a camera apparatus according to one embodiment of the present invention comprises a cylindrical lens barrel 10, a zoom lens module 20 and a focusing lens module 30 installed inside the lens barrel 10, an iris diaphragm 40 to adjust an amount of entering light, and a motor 50 to drive the iris diaphragm 40.

The cylindrical lens barrel 10 comprises a pair of cylinders 11 and 12 which are engaged with each other. The first cylinder 11 may comprise an objective lens module 13 at an entry part 11a of a leading end of the first cylinder 11. The second cylinder 12 may be engaged with a substrate (not shown) having a CCD module thereon at a rear end of the second cylinder 12.

The zoom lens module 20 is movable within the cylindrical lens barrel 10. More specifically, the zoom lens module 20 may be formed to be moved forward and backward by a corresponding moving device (not shown) along a direction substantially parallel to an entering light L. In this way, a zooming operation is performed by the zoom lens module 20 with respect to the subject of the photographing.

The focusing lens module 30 is also movable within the cylindrical lens barrel 10. The focusing lens module 30 is installed at a rear part of the zoom lens module 20, and performs a focusing operation with respect to the subject of the photographing. The corresponding moving device (not shown) moves the focusing lens module 30 forward and backward along a direction that is substantially parallel to the entering light L. Any adequate general method or apparatus may serve as the moving device of the zoom lens module 20 and the focusing lens module 30. In one instance, a guide shaft may be installed within the cylindrical lens barrel 10 to support the respective modules 20 and 30. A motor driven lead screw may then selectively move the modules 20 and 30. Further detailed description of the module driving device will be omitted.

The iris diaphragm 40 is installed within the cylindrical lens barrel 10, and between the respective modules 20 and 30. The iris diaphragm 40 adjusts an amount of light that enters the cylindrical lens barrel 10. The iris diaphragm 40 is movable in a radial direction therefore that is substantially perpendicular to the direction of entered light L. The iris diaphragm 40 will be described in detail below.

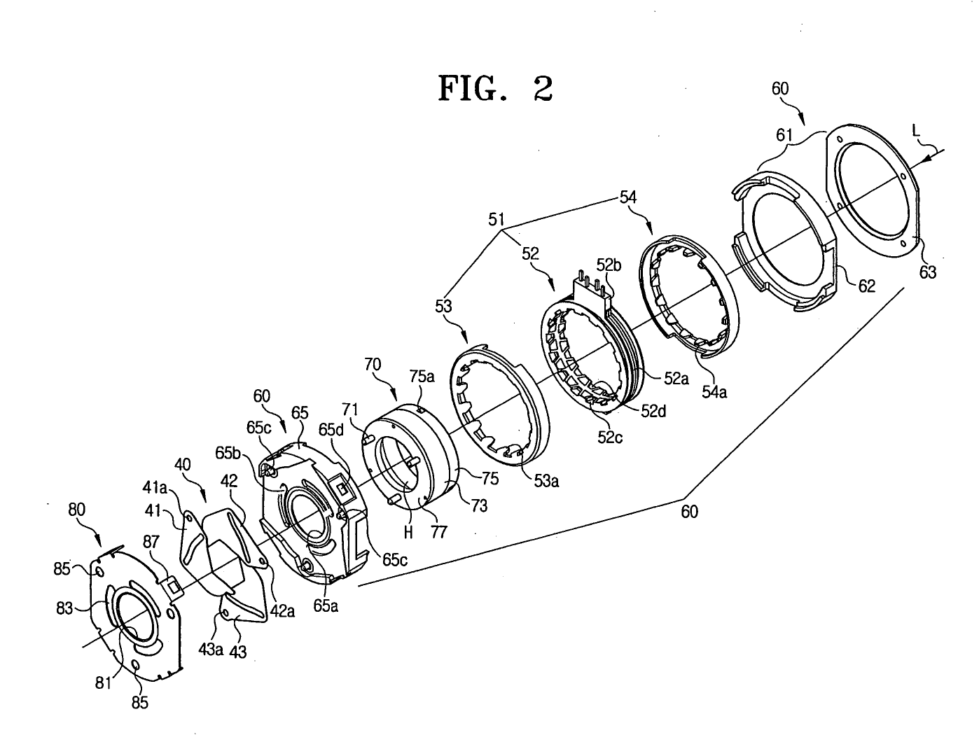

The motor 50 is installed within the cylindrical lens barrel 10. According to one aspect of the present invention, a stepping motor may be employed to provide a rotary force according to predetermined increments. Referring to FIG. 2, the motor 50 comprises a stator assembly 51, a motor housing 60, and a rotor 70 installed within the stator assembly 51.

The stator assembly 51 is installed within the motor housing 60. The stator assembly 51 comprises a substantially annular bobbin 52, and first and second stator members 53 and 54 that are engaged to both ends of the annular bobbin 52, respectively.

A coil 52a is wound around the annular bobbin 52, to electrically connect with an external terminal via a terminal part 52b provided at an outer surface of the annular bobbin 52.

As mentioned above, the first and the second stator members 53 and 54 are engaged to both ends of the annular bobbin 52, respectively, so as to be in alignment with each other. Each of the stator members 53 and 54 is provided with circumferentially-spaced fastening teeth 53a and 54a. The circumferentially-spaced fastening teeth 53a and 54a engage in the inner circumference of the annular bobbin 52 in a staggered fashion. Accordingly, the annular bobbin 52 comprises a plurality of teeth grooves 52c and 52d to receive the circumferentially-spaced fastening teeth 53a and 54a. The teeth grooves 52c and 52d are also formed in a staggered fashion. When an electric signal is inputted to the coil 52a according to a predetermined pattern, the respective fastening teeth 53a and 54a are magnified according to the input pattern of the electric signals and, therefore, become an electromagnet. As a result of the electro-magnetic force that is generated between the electromagnets, i.e., the circumferentially-spaced fastening teeth 53a and 54a and the rotor 70, the rotor 70 is rotated by a predetermined unit angle.

The rotor 70 is rotatable within the stator assembly 51. The rotor 70 has a center hole H formed therein through which the entering light L passes through. To permit the light L to pass, the rotor 70 is not provided with a rotary shaft. The rotor 70 has a plurality of driving pins 71 to move the iris diaphragm 40 according to the movement of the driving pins 71. In this embodiment, the iris diaphragm 40 has three lens shutters 41, 42 and 43. The three driving pins 71 are provided at equal intervals to correspond to the lens shutters 41, 42 and 43.

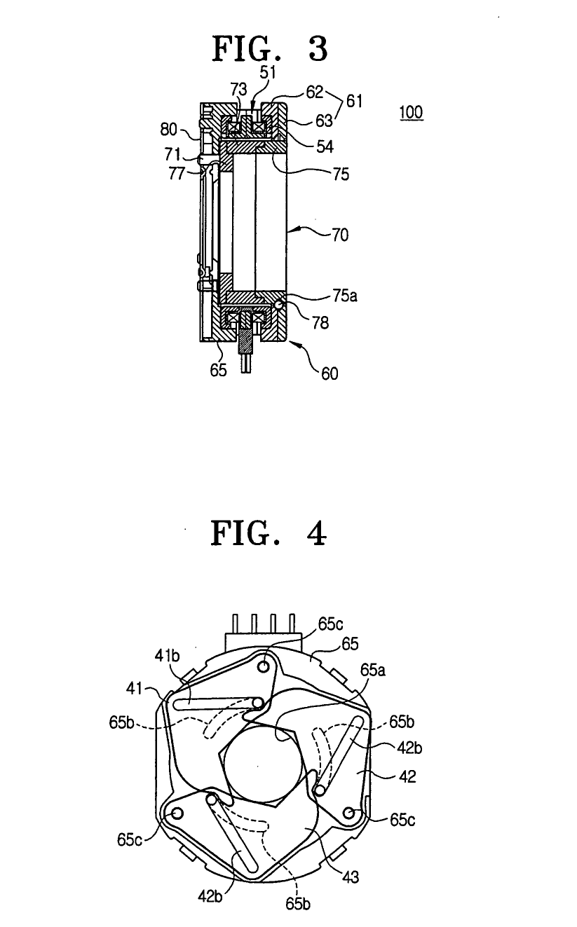

Referring to FIG. 3, the rotor 70 according to this embodiment comprises a cylindrical magnet 73, a tubular sleeve 75 to engage with one end of the cylindrical magnet 73, and a plate 77 to engage with the other end of the cylindrical magnet 73. The magnet 73 is magnetized to N-pole and S-pole at certain intervals along the direction of rotation. The tubular sleeve 75 takes on the similar cylindrical configuration as that of the magnet 73, and is engaged to one end of the magnet 73. A plurality of bearing receiving holes 75a are formed along the outer circumference of the tubular sleeve 75 such that, with the bearing 78 received in the bearing receiving holes 75a, the tubular sleeve 75 is supported in contact with the inner surface of the motor housing 60. The plate 77 allows the driving pins 71 to protrude therefrom. The driving pins 71 may be formed by insert-molding during the manufacturing of the plate 77. The driving pins 71 are movably supported on the motor housing 60. The rotor 70 is hollow at a center portion of the inner circumference, and rotatably disposed within the stator assembly 51.

According to another aspect of the present invention, the rotor 70 may be formed by integrally forming the magnet 73, the tubular sleeve 75 and the plate 77. In this case, the entire rotor 70 is formed of a magnet material, and the driving pins 71 may also be integrally formed thereon by insert-molding.

The motor housing 60 is firmly mounted in the cylindrical lens barrel 10. The motor housing 60 comprises a first and a second housing 61 and 65 which house the stator assembly 51.

The first housing 61 supports the bearing 78 of the rotor 70. As shown in FIGS. 2 and 3, the first housing 61 may enclose the second stator member 54 when the first housing 61 is engaged with the second housing 65. The first housing 61 may be formed with separate parts, such as front and rear brackets 62 and 63. The respective brackets 62 and 63 are separately fabricated, and are engaged with the second stator member 54. The boundary of the brackets 62 and 63 may act as a guidance groove to guide the bearing 78. That is, during the rotation of the rotor 70, the bearing 78 is guided along the boundary of the brackets 62 and 63 to support the rotor 70. The brackets 62 and 63 may of course be integrally formed with each other, and in this case, a guide groove is formed along the inner circumference of the first integrally-formed housing 61.

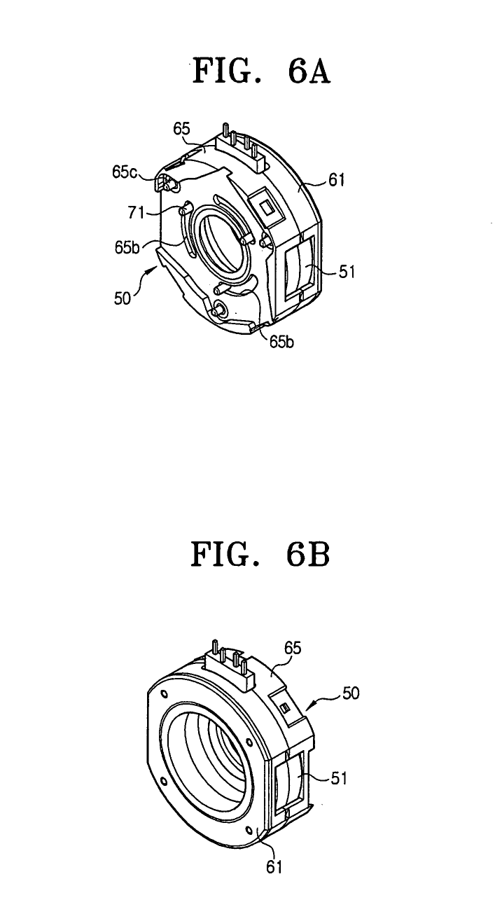

As shown in FIGS. 6A and 6B, the second housing 65 is engaged with the first housing 61 with the stator assembly 51 placed therebetween. The second housing 65 has a center aperture 65a which is opened and closed by the iris diaphragm 40. There are a plurality of guide slits 65b formed around the center aperture 65a within which the driving pins 71 are disposed and moved. The guide slits 65b are formed with lengths corresponding to the rotational angle of the rotor 70. The driving pins 71 are supported in the state of being inserted and through in the guide slits 65b. The driving pins 71 are moved along the guide slits 65b by the rotating rotor 70.

The second housing 65 has shaft bosses 65c on which the lens shutters 41, 42 and 43 are rotatably supported. In this embodiment, three shaft bosses 65c are provided to correspond to the lens shutters 41, 42 and 43. The shaft bosses 65c are distanced apart from the center aperture 65a as far as possible. This is to enable efficient opening and closing of the center aperture 65a even when the lens shutters 41, 42 and 43 are rotated about the shaft bosses 65c by a small angle.

Referring to FIG. 4, each of the lens shutters 41, 42 and 43 has a cam slit 41b, 42b and 43b to facilitate the insertion of the driving pins 71. The lens shutters 41, 42 and 43 are shaped and sized in a uniform manner. According to the movement of the driving pins 71 which are turned along the cam slits 41b, 42b and 43b, the lens shutters 41, 42 and 43 are rotated, to adjust the size of the center aperture 65a so as to adjust the amount of entering light L. In the present embodiment, the cam slits 41b, 42b and 43b are formed in a linear manner and with a predetermined length.

By adjusting the rotational angle of the rotor 70 appropriately, the linear cam slits 41b, 42b and 43b adjust the opening and closing of the lens shutter 40, i.e., adjust the f-number of the incident light L.

Referring to FIG. 2, a housing cover 80 is additionally provided. The housing cover 80 is removably attached to the second housing 65, and prevents the iris diaphragm 40 from separating from the second housing 65. The housing cover 80 has a center hole 81 corresponding to the center aperture 65a of the second housing 65. Slits 83 are disposed around the center hole 81 of the housing cover 80 to correspond with the guide slits 65b of the second housing 65. Accordingly, the housing cover 80 has a plurality of holes 85 corresponding to the shaft bosses 65c of the second housing 65. An elastically-deformable locking protrusion 87 is formed around the boundary of the housing cover 80 to lock with the corresponding locking hole 65d formed in the outer circumference of the second housing 65.

The process of assembling the iris diaphragm driving apparatus of a camera apparatus according to one certain embodiment of the present invention will be described below.

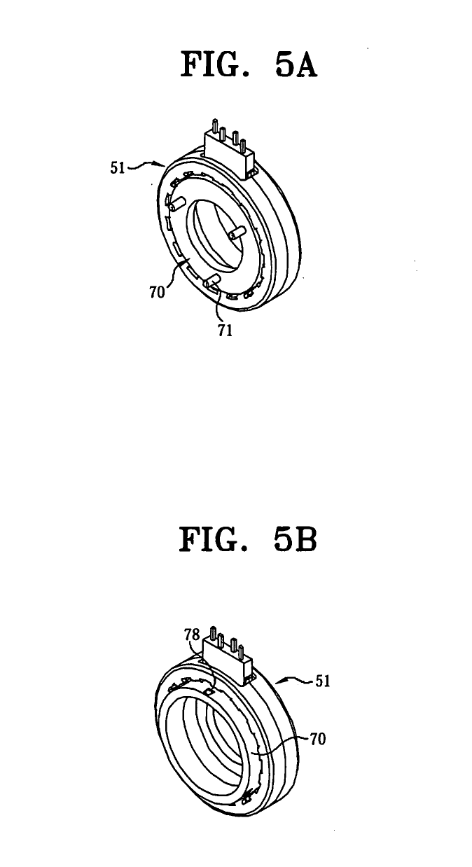

First, the stator assembly 51 as shown in FIG. 2 is assembled. The rotor 70 is disposed within the assembled stator assembly 51. Referring to FIGS. 5A and 5B, the rotor 70 is rotatably inserted in the stator assembly 51 at a certain distance from the inner circumference of the stator assembly 51. In other words, the rotor 70 is not supported in the stator assembly 51. Then as shown in FIGS. 6A and 6B, the first and the second housings 61 and 65 are engaged, enclosing the stator assembly 51. Accordingly, the driving pins 71 of the rotor 70 are inserted and supported in the guide slits 65b of the second housing 65. The bearing 78 on the outer circumference of the rotor 70 is supported in the first housing 61. When the motor 50 is assembled, a length of angular rotation of the rotor 70 is in accordance with the linear length of the guide slits 65b.

The assembling of the motor 50 is then completed, and the lens shutters 41, 42 and 43 are the engaged on the driving pins 71 and the shaft bosses 65c, with certain parts overlapping with one another.

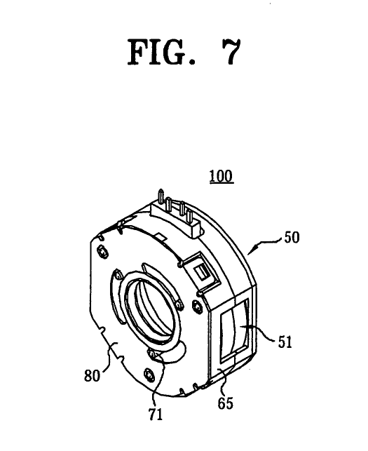

In order to prevent a disassembly of the lens shutters 41, 42 and 43 from the second housing 65, as shown in FIG. 7, the housing cover 80 is assembled to the second housing 65. Accordingly, an iris diaphragm driving apparatus 100 is completely assembled.

Referring to FIG. 1, the iris diaphragm driving apparatus 100 assembled as above is installed within the cylindrical lens barrel 10. Other components of the cylindrical lens barrel 10, such as zoom lens module 20 and the focusing lens module 30 are assembled in a general way.

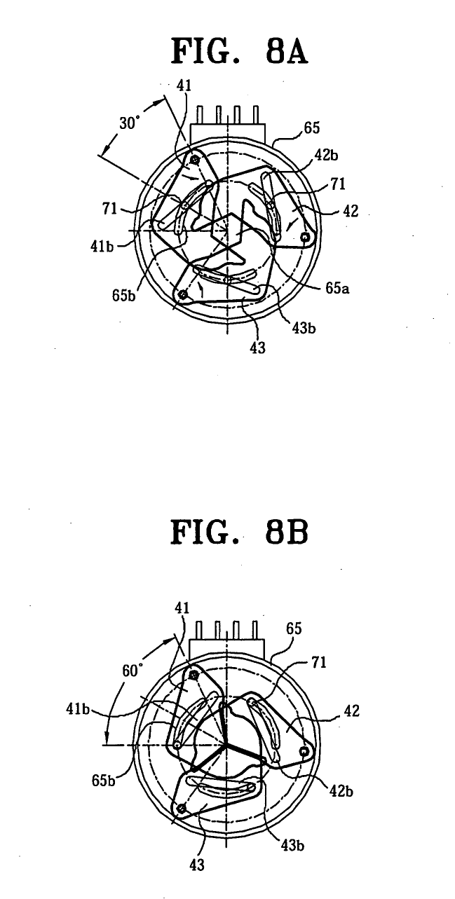

Referring now to FIGS. 4, 8A and 8B, the opening and closing of the iris diaphragm 40 according to an embodiment of the present invention will be described below.

In FIG. 4, the iris diaphragm 40 is completely open, which means the lens shutters 41, 42 and 43 are not overlaid on the center aperture 65a, but spread open. When the rotor 70 is rotated by a predetermined angle, as shown in FIG. 8A, the lens shutters 41, 42 and 43 are rotated by a corresponding angle to partially close the center aperture 65a.

When the rotor 70 is further rotated, as shown in FIG. 8B, the lens shutters 41, 42 and 43 are rotated to the extreme end of the available rotation angle, and therefore, completely close the center aperture 65a. In FIG. 8B, the lens shutters 41, 42 and 43 are closed toward the center of the center aperture 65a, while overlapping partially with one another. The lens shutters 41, 42 and 43 are moved by the movement of the driving pins 71 of the rotor 70 which are rotated along the cam slits 41b, 42b and 43b. In the present embodiment, the cam slits 41b, 42b and 43b are substantially linear, and accordingly, the unit rotational angle of the rotor 70 is non-linearly controlled to control the center aperture 65a, i.e., the f-number of the incident light L in a stepwise manner.

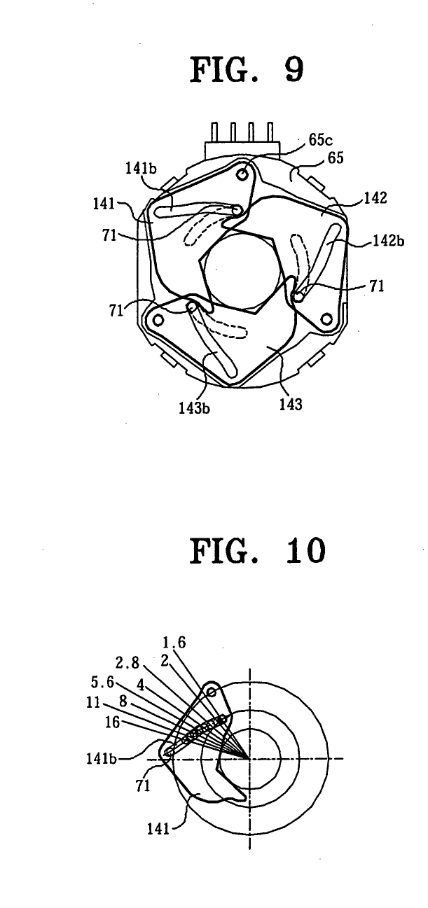

According to another embodiment of the present invention as shown in FIG. 9, the lens shutters 141, 142 and 143 each has a cam slit 141b, 142b and 143b which is formed in a non-linear shape, at least at a part thereof. As shown in FIG. 10, the cam slits 141b, 142b and 143b are formed in an appropriate configuration which can be obtained experimentally, to achieve a certain appropriate f-number when the driving pins 71 are moved by a predetermined rotational unit angle. Accordingly, when the rotor 70 is rotated by a predetermined angle, the f-number may be adjusted as predetermined. This alternative embodiment provides an advantage of easy control of opening and closing degree of the lens shutters 141, 142 and 143.

As is described above in a few embodiments of the present invention, a motor, an iris diaphragm driving apparatus and a camera apparatus may have a simple structure so as to enable the driving of a lens shutter by using a motor which may be inserted in the lens barrel. Specifically, because there is no need to install the motor on the outer part of the lens barrel, a variety of designs may be selected for the outer part, and also, compactness is enabled.

Furthermore, because the lens shutters may be directly connected to the rotor of the motor, precision in controlling the product is improved, and as a result, reliability is enabled.

Although a few embodiments of the present invention have been shown and described, it would be appreciated by those skilled in the art that changes may be made in these embodiments without departing from the principles and spirit of the invention, the scope of which is defined in the claims and their equivalents.

1. A motor to drive an iris diaphragm to allow an adjustment of an amount of light that enters a lens barrel, the motor comprising:
a motor housing formed within the lens barrel to provide a light path;
a stator assembly supported in the motor housing; and
a rotor rotatably disposed within the stator assembly to move the iris diaphragm as a result of a movement of the rotor, the rotor having a center aperture through which the light path extends.

2. The motor of claim 1, wherein the motor housing rotatably supports the iris diaphragm.

3. The motor of claim 1, wherein the rotor comprises a driving pin to move the iris diaphragm in accordance with the movement thereof.

4. The motor of claim 3, wherein the motor housing comprises:
a shaft boss to rotatably support the iris diaphragm; and
a guide part to guide the movement of the driving pin.

5. The motor of claim 4, further comprising a housing cover attached to the motor housing to prevent the iris diaphragm from releasing from the shaft boss and the driving pin.

6. The motor of claim 5, wherein the housing cover comprises:
an engagement hole corresponding to the shaft boss; and
a supporting slit provided to correspond with the guiding part to support the driving pin.

7. The motor of claim 3, wherein the driving pin is plural in number and the plurality of the driving pins are arranged at uniform intervals with respect to the light path.

8. The motor of claim 3, wherein the driving pin is integrally formed with the rotor.

9. The motor of claim 1, wherein the stator assembly comprises:
a hollow bobbin having a coil that is wound around an outer circumference;
a first stator member to engage with a first end of the hollow bobbin, and having first fastening teeth formed at equal intervals; and
a second stator member to engage with a second end of the hollow bobbin so as to be in alignment with the first stator member, the second stator member having second fastening teeth formed at equal intervals and in a staggered manner with respect to the first fastening teeth.

10. The motor of claim 1, wherein the motor housing comprises:
a first housing enclosing to support one side of the stator assembly, and having a hollow space therein to provide the light path; and
a second housing formed in alignment with the first housing with the stator assembly interposed therebetween, the second housing having a hollow space therein to provide the light path.

11. The motor of claim 1, wherein the rotor is rotatably supported in the motor housing.

12. The motor of claim 11, wherein the rotor has a plurality of bearing receiving holes on the outer circumference, and the motor housing has a bearing guide hole.

13. The motor of claim 3, wherein the rotor is a cylindrical magnet which is integrally formed with the driving pin and magnetized at predetermined intervals along the direction of rotation.

14. The motor of claim 3, wherein the rotor comprises:
a cylindrical magnet that is magnetized at predetermined intervals along the direction of rotation, and rotatably supported in the motor housing;
a tubular sleeve that is connected to a first end of the cylindrical magnet, and rotatably disposed within the stator assembly; and
a plate that is connected to the first end of the magnet, and having a driving pin to move the iris diaphragm with the movement of the driving pin.

15. The motor of claim 14, wherein the driving pin is integrally formed with the plate, and movably supported in the motor housing.

16. The motor of claim 1, wherein the iris diaphragm comprises a plurality of lens shutters which are rotatably disposed on the housing.

17. The motor of claim 1, further comprising a housing cover to engage with the motor housing to prevent the separation of the iris diaphragm.

18. A motor to drive an iris diaphragm, comprising:
a driving part including a rotor to provide a light path at a center of rotation, and a stator assembly provided at an outer side of the rotor;
a motor housing to enclose the driving part therein, and to provide the light path;
a housing cover tube removably engaged with the motor housing,
wherein the rotor opens and closes the light path by moving the iris diaphragm interposed between the housing cover and the motor housing in accordance with a movement of the rotor.

19. The motor of claim 18, wherein the rotor comprises at least one driving pin extended in between the housing cover and the motor housing to move the iris diaphragm in accordance with the rotation of the rotor.

20. An iris diaphragm driving apparatus, comprising:
an iris diaphragm disposed on a light path of a lens barrel, to adjust an amount of entering light in accordance with a moving position of the iris diaphragm; and
a driving unit disposed in the lens barrel to drive the iris diaphragm, and to provide the light path at a center of rotation through which the entering light passes.

21. The iris diaphragm driving apparatus of claim 20, wherein the driving unit comprises:
a motor housing to support the iris diaphragm, and to be disposed within the lens barrel;
a stator assembly disposed within the motor housing; and
a rotor rotatably disposed within the stator assembly to move the iris diaphragm in accordance with a movement of the rotor.

22. The iris diaphragm driving apparatus of claim 21, wherein the rotor comprises at least one driving pin to move the iris diaphragm in accordance with a movement of the rotor.

23. The iris diaphragm driving apparatus of claim 22, wherein the motor housing comprises:
a shaft boss rotatably supporting the iris diaphragm; and
a guidance part to guide the movement of the driving pin.

24. The iris diaphragm driving apparatus of claim 22, wherein the iris diaphragm comprises a plurality of lens shutters which are rotatably disposed on the motor housing.

25. The iris diaphragm driving apparatus of claim 22, wherein the plurality of lens shutters each comprises:
a shaft hole as a center of rotation; and
a cam slit to engage with one of the at least one driving pin.

26. The iris diaphragm driving apparatus of claim 25, wherein the cam slit takes on a substantially linear configuration and has a predetermined length.

27. The iris diaphragm driving apparatus of claim 25, wherein the cam slit takes on a substantially curved configuration and has a predetermined length, and the lens shutter is movable to obtain an f-number which is set in proportion to the unit rotation angle of the rotor.

28. The iris diaphragm driving apparatus of claim 24, wherein three lens shutters are rotatably arranged around the light path in a radial direction at equal intervals, and three driving pins are provided in alignment with the three lens shutters.

29. The iris diaphragm apparatus of claim 21, further comprising a housing cover which is removably attached to the motor housing, to rotatably support the iris diaphragm which is interposed between the housing cover and the motor housing.

30. A camera apparatus, comprising:
a lens barrel;
a zoom lens module installed within the lens barrel;
a focusing lens module installed within the lens barrel;
an iris diaphragm movably installed between the zoom lens module and the focusing lens module, to adjust an amount of entering light in accordance with a moving position thereof; and
a driving unit, installed within the lens barrel to drive the iris diaphragm, to provide a light path at a center thereof through which the light that has passed the zoom lens module is passed.

31. The camera apparatus of claim 30, wherein the driving unit comprises:
a motor housing installed within the lens barrel, to rotatably support the iris diaphragm;
a stator assembly installed within the motor housing; and
a rotor rotatably disposed within the stator assembly to move the iris diaphragm in accordance with a movement of the rotor.

32. The camera apparatus of claim 31, wherein the rotor comprises at least one driving pin to move the iris diaphragm in accordance with a movement thereof.

33. The camera apparatus of claim 32, wherein the iris diaphragm comprises a plurality of lens shutters which are rotatably disposed on the motor housing.

34. The camera apparatus of claim 33, wherein the plurality of lens shutters each comprises:
a shaft hole as a center of rotation; and
a cam slit to engage with the at least one driving pin, the driving pin being in movable engagement with the cam slit.

35. The camera apparatus of claim 31, wherein the rotor is rotatably supported in the motor housing, and having a hollow hole therein to provide a light path at a center of rotation.

36. The camera apparatus of claim 35, wherein at least one of the zoom lens module and the focusing lens module is disposed in the hollow hole of the rotor.

37. The camera apparatus of claim 32, wherein the driving pin is formed by insert-molding such that the driving pin is exposed through one end of the rotor.

38. A method of assembling a motorized camera, including an iris diaphragm that is controlled by a motor in a motor housing inside a lens barrel of the camera, the method comprising:
providing a stator assembly in the motor housing;
rotatably inserting a rotor, having driving pins protruding therefrom and a bearing on an outer circumference thereof, in the stator assembly at a distance from the inner circumference of the stator assembly such that the rotor is not supported in the stator assembly;
engaging first and second housings with each other to enclose the stator assembly, the second housing including guide slits such that the driving pins are inserted through and supported by the guide slits and the bearing is supported by the first housing.

39. The method according to claim 38, further comprising engaging lens shutters with the driving pins and bosses to overlap each other.

40. The method according to claim 39, further comprising assembling a housing cover with the second housing to prevent disassembly of the shutters.

41. The method according to claim 40, wherein the motor drives the rotor to rotate such that a length of the rotation of the rotor is limited in accordance with the linear length of the guide slits.

42. A method of assembling a motorized camera, including an iris diaphragm controlled by a motor in a motor housing inside a lens barrel of the camera, the method comprising:
providing a stator assembly in the motor housing;
rotatably inserting a rotor, having driving pins protruding therefrom and a bearing on an outer circumference thereof, in the stator assembly at a distance from the inner circumference of the stator assembly such that the rotor is not supported in the stator assembly;
engaging first and second housings with each other to enclose the stator assembly, the second housing including guide slits such that the driving pins are inserted through and supported by the guide slits and the bearing is supported by the first housing, wherein the motor drives the rotor to rotate such that a length of the rotation of the rotor is limited in accordance with a linear length of the guide slits.

43. The method according to claim 42, further comprising engaging lens shutters with the driving pins and bosses to overlap each other.

44. The method according to claim 42, further comprising assembling a housing cover with the second housing to prevent disassembly of the shutters.

45. A camera, including an iris diaphragm which is controlled by a motor in a motor housing inside a lens barrel of the camera, the camera being made by a process including the operations of:
providing a stator assembly in the motor housing;
rotatably inserting a rotor, having driving pins protruding therefrom and a bearing on an outer circumference thereof, in the stator assembly at a distance from the inner circumference of the stator assembly such that the rotor is not supported in the stator assembly;
engaging first and second housings with each other to enclose the stator assembly, the second housing including guide slits such that the driving pins are inserted through and supported by the guide slits and the bearing is supported by the first housing.

46. The method according to claim 45, further comprising engaging lens shutters with the driving pins and bosses to overlap each other.

47. The method according to claim 46, further comprising assembling a housing cover with the second housing to prevent disassembly of the shutters.

48. The method according to claim 47, wherein the motor drives the rotor to rotate such that a length of the rotation of the rotor is limited in accordance with the linear length of the guide slits.

49. A camera, including an iris diaphragm which is controlled by a motor in a motor housing inside a lens barrel of the camera, the camera being made by a process including the operations of:
providing a stator assembly in the motor housing;
rotatably inserting a rotor, having driving pins protruding therefrom and a bearing on an outer circumference thereof, in the stator assembly at a distance from the inner circumference of the stator assembly such that the rotor is not supported in the stator assembly;
engaging first and second housings with each other to enclose the stator assembly, the second housing including guide slits such that the driving pins are inserted through and supported by the guide slits and the bearing is supported by the first housing, wherein the motor drives the rotor to rotate such that a length of the rotation of the rotor is limited in accordance with the linear length of the guide slits.

50. The method according to claim 49, further comprising engaging lens shutters with the driving pins and bosses overlapping each other.

51. The method according to claim 50, further comprising assembling a housing cover with the second housing to prevent disassembly of the shutters.

52. A motor to drive an iris diaphragm to allow an adjustment of an amount of light that enters a lens barrel, the motor comprising:
a motor housing formed within the lens barrel to provide a light path through which the light that enters the lens barrel extends;
a rotor to move the iris diaphragm as a result of a rotational movement of the rotor, the rotor having a center aperture through which the light path extends; and
a stator assembly supported in the motor housing which is magnified so as to cause the rotor to rotate.
